(19) United States
(12) Patent Application Publication
(10) Pub. No.: US 2012/0320054 A1
(43) Pub. Date: Dec. 20, 2012

(54) Apparatus, System, and Method for 3D Patch Compression

(75) Inventors: Gustavo Chavez, Thuwal (SA); Alyn Rockwood, Thuwal (SA)

(73) Assignee: King Abdullah University of Science and Technology, Thuwal (SA)

(21) Appl. No.: 13/524,489

(22) Filed: Jun. 15, 2012

Related U.S. Application Data
(60) Provisional application No. 61/497,463, filed on Jun. 15, 2011.

(51) Int. Cl. G06T 17/20; G06T 15/00

(52) U.S. Cl. 345/423; 345/419

(57) ABSTRACT

An apparatus, system, and method for creating, viewing and manipulating 3D patch compressed images.

### CLAIM OF PRIORITY

This application claims priority to U.S. Provisional Patent Application No. 61/497,463 filed on Jun. 15, 2011, which is hereby incorporated by reference in its entirety.

### BACKGROUND OF THE INVENTION

1. Field of the Invention

This invention relates to 3D compression and more particularly relates to an apparatus system and method for 3D compression and the use of 3D compression in ecommerce.

2. Description of the Related Art

Traditionally, three dimensional (3D) images are represented by mesh or points in a 3D grid. These 3D images tend to be contained in large files that are hard to compress without a loss of quality. Mobile and internet technology is constrained by the current 3D format technology, as these large files take long periods to transfer from computer to computer or server to mobile device. The time it takes to transfer and modify these 3D image files is hindering the advance of mobile applications that make use of 3D image rendering and manipulation. What is needed is a lightweight 3D image format that can be easily manipulated and quickly transferred across both wired and wireless connections for real-time applications.

Lightweight visualization is a process of compressing an engineering model to one that is smaller and marginally different from the original, while maintaining close visual similarity. The approach is used to represent large multisided areas with single patches, instead of a plethora of rectangular B-spline surfaces. The patched surface representation creates much smaller file size while maintaining a high quality three dimensional (3D) image. This application may be used in such industries as web browsers, mobile devices, video games, movies, medical, aeronautics, automotive, clothing, architecture, and any industry that deals with 3D representation of objects, especially in devices with restriction of computing capabilities and broad band.

Current implementations of 3D image storage include recursive subdivision, algorithm decimation, non-uniform rational B-spline (NURBS), and B-spline patches. Embodiments of this invention focus on using feature curves compression, which saves the feature curves of an object and then uses multisided patches to replace the set of polygons. This n-sided technology is used as the underlying technology to compress 3D data to create 3D patch compressed objects.

### SUMMARY OF THE INVENTION

Embodiments of apparatuses methods and system for 3D patch compression are described. An embodiment of the invention is an apparatus to 3D patch compression of digital objects, the apparatus comprising 1) a 3D model receiving module configured to receive a 3D model; 2) a compression module configured to compress the 3D file by transforming the 3D model into a 3D patch compressed model; 3) a 3D patch compressed visualization module configured to view the 3D patch compressed model; and 4) a 3D patch compressed manipulation module configured to manipulate the 3D patch compressed model. The received 3D models may be 3D mesh, vertices or connection arrays or NURBS representations, for example. The apparatus may further comprise a quality measure module configured to measure the quality of the main feature patches. The quality measure module may be configured to use volume between patch and original surface, or curves identification to measure the quality of the main feature patches. The 3D patch compressed visualization module may also be configured to give a 360 degree view of the 3D patch compressed model.

The compression module may further comprise a feature identification module is configured to identify main features of the 3D model, a patch module configured to patch the main features of the 3D model, and a patch joining module configured to join the main feature patches. In specific embodiments of the invention, the feature identification module is configured to use surface eigenvalues, curvature information, or orthogonal cuts to identify the main features, for example. The patch joining module may be configured to merge adjacent patches according to neighbor control points taken from the received 3D model by matching the first derivatives and/or second derivatives.

The 3D model receiving module may also be configured to receive a 3D model of a human body. The 3D patch compressed manipulation model may be further configured to manipulate measurements of the 3D model of a human body. In one embodiment, 3D patch compressed model poses may be saved and put in order, such that the 3D patch compressed model can be animated.

The apparatus may further comprise a texture map receiving module configured to receive a texture map and a texture mapping module configured to texture map the joined patches with the texture map. The texture mapping module may be configured to texture map a representation of clothing onto a 3D model of a human body or to texture map a representation of a human face onto a 3D model of a human body. The 3D patch compressed manipulation module may be further configured to modify the texture mapping of the 3D model. Further, the 3D patch compressed manipulation module may be configured to change the quality of the 3D patch compressed model, or further configured to change measurements of the 3D patch compressed model. The manipulation model may be further configured to fit a second 3D patch compressed model onto the first patch compressed 3D model, for example, fitting a 3D patch compressed model of clothing on to a patch compressed 3D model of a human body.

Another embodiment of the invention is a computer program product comprising a computer readable medium having computer usable program code executable to perform operations for 3D patch compressing images, the operations of the computer program product comprising: receiving a 3D model; compressing the 3D model by transforming the 3D model into a 3D patch compressed model; viewing the 3D patch compressed model; manipulating the 3D patch compressed model; and outputting the 3D patch compressed model. The received 3D models may be in a 3D mesh, vertices or connection arrays representation. The 3D model may also be a model of a human body.

Joining the main feature patches may comprise merging adjacent patches according to neighbor control points taken from the received 3D model by matching the first derivatives and/or second derivatives. In an embodiment of the invention, the quality of the main feature patches is measured. Measuring the quality of the main feature patches may comprise calculating the volume between the received 3D model and the 3D patch compressed model, or b-spline curves identification. Manipulating the 3D patch compressed model may comprise manipulating measurements of the 3D model of a human body or fitting another 3D patch compressed model to the 3D patch compressed model. The computer program product may further comprise receiving a texture map and texture mapping the joined patches with the texture map. A texture map may be a representation of a piece of clothing, or a representation of a human face, for example. Manipulating the 3D patch compressed model may comprise modifying the texture mapping of the 3D model, changing the quality of the 3D patch compressed model, changing measurements of the 3D patch compressed model, or fitting another 3D patch compressed model to the original 3D patch compressed model, such as fitting a 3D patch compressed model of a human body to a 3D patch compressed model of a pair of pants.

In a further embodiment, compressing the 3D model further comprises identifying main features of the 3D model; patching the main features of the 3D model; and joining the main feature patches together. In another further embodiment, identifying the main features of the 3D model comprises calculating the second and/or third eigen mode of the laplacian on the parametric surface of the model. Identifying the main features of the 3D model may comprise identifying places with principal-curvature information and patching along the identified places. In another embodiment, identifying the main features of the 3D model comprises taking 3D model surface and intersecting it with orthogonal places and estimating the intersection.

Another embodiment of the invention is an apparatus to view and manipulate 3D patch compressed model, the apparatus comprising: a 3D model receiving module configured to receive a 3D patch compressed model; a 3D patch compressed visualization module configured to view the 3D patch compressed model; and a 3D patch compressed manipulation module configured to manipulate the 3D patch compressed model. The method may further comprise a texture map receiving module configured to receive a texture map and a texture mapping module configured to texture map the joined patches with the texture map. The texture map may be a 3D model of a human body. The 3D patch compressed manipulation model may be further configured to manipulate measurements of the 3D model of a human body. In specific embodiments of the invention, the texture mapping module is configured to texture map a representation of clothing onto a 3D model of a human body or texture map a representation of a human face onto a 3D model of a human body. The 3D patch compressed manipulation module may be further configured to modify the texture mapping of the 3D model, change the quality of the 3D patch compressed model, or change measurements of the 3D patch compressed model. The 3D patch compressed visualization module may be configured to give a 360 degree view of the 3D patch compressed model. The 3D patch compressed manipulation model may also be configured to fit a second 3D patch compressed model on the original 3D patch compressed model. These embodiments may also be implemented as a computer program product comprising a computer readable medium having computer usable program code executable to perform the operations of these embodiments.

A further general embodiment of the invention is a system to 3D patch compress images, the system comprising: a data storage device configured to store a database comprising one or more 3D patch compressed base models; a data storage device configured to store a database comprising one or more 3D patch compressed models on a server in data communication with the data storage device, suitably programmed to: fit one or more 3D patch compressed models to a 3D patch compressed base model and send the fit 3D patch compressed texture model.

Another general embodiment of the invention is a method for 3D patch compressing a model, the method comprising: receiving a 3D representation of a first model; receiving a texture map or a second patch compressed model; identifying the main features of the first model; patching the identified main features of the first model; joining the patches; texture mapping the joined patches with the texture map or fitting the second 3D patch compressed model to the joined patches; and sending a compressed texture mapped model to a visualization device. The received 3D representation of a model may be a 3D mesh, vertices or connection arrays representation. An embodiment may further comprise measuring the quality of the main feature patches. The received 3D model may be a model of the human body. Specific embodiments may further comprise manipulating measurements of the 3D model of a human body. Received texture maps may be a picture of a human face, a picture or 3D patch compressed image of clothing. The patching method may comprise using a surface-eigen value algorithm, a curvature information algorithm, or an orthogonal cut algorithm and the measuring the quality of the main feature patches may comprise calculating the volume between the patched model and the original model or identifying the curves as b-splines. Joining or merging patches may comprise merging adjacent patches according to neighbor control points and matching the one or more derivative, for example a first and a second derivative. In an embodiment of the invention, manipulating the model may comprise changing the quality of the 3D patch compressed model or changing measurements of the 3D patch compressed model.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for 3D patch compression;

FIG. 2 is a schematic block diagram illustrating one embodiment of a database system for 3D patch compression;

FIG. 3 is a schematic block diagram illustrating one embodiment of a computer system that may be used in accordance with certain embodiments of the system for 3D patch compression;

FIG. 4 is a schematic logical diagram illustrating one embodiment of abstraction layers of operation in a system for 3D patch compression;

FIG. 5 is a schematic block diagram illustrating one embodiment of an apparatus for 3D patch compression;

FIG. 6 is a flow chart illustrating one embodiment of the method of 3D patch compression.

FIG. 7 is a flow chart for one embodiment of the method of 3D patch compression used in ecommerce;

FIG. 8 is a screenshot for one embodiment of the method used in ecommerce;

FIG. 9 is a an example screenshot for one embodiment of model manipulation;

FIG. 10 is a screenshot of avatar manipulation on a tablet computer.

FIG. 11 is a screenshot of a model manipulation used in an ecommerce application on an iPhone.

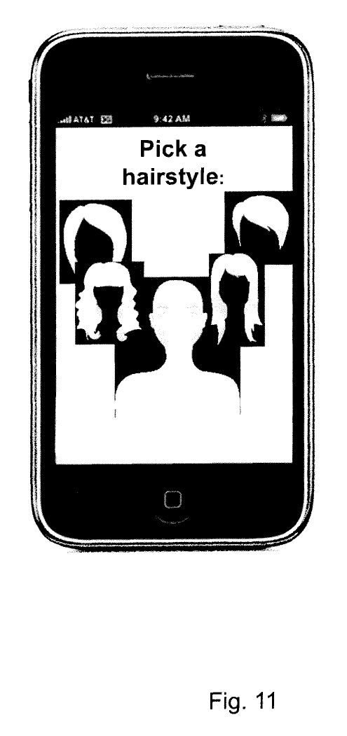

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a machine or machines executable instructions.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

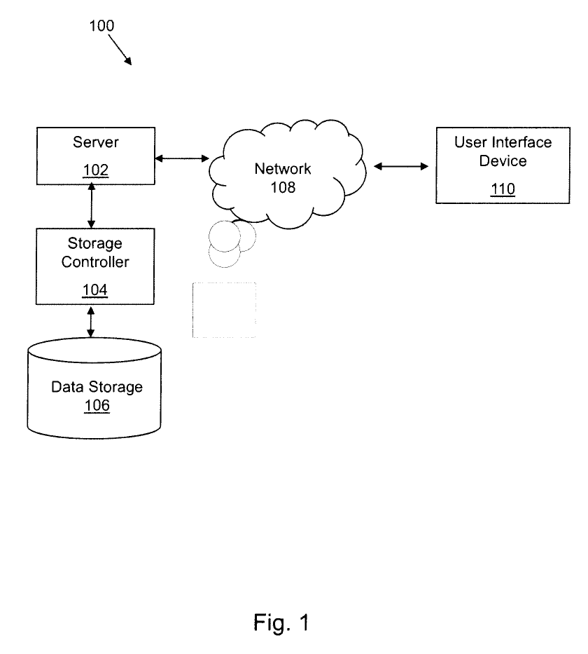

FIG. 1 illustrates one embodiment of a system 100 for 3D compression. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provides a user interface for enabling a user to enter or receive information. For example, the user may enter the address of a webpage into a mobile device to access a website comprising 3D data. The user may interact with the site through a web browser and the input apparatus of the mobile device. The user may select information corresponding to 3D data and the 3D data will be displayed on the users mobile device as a 3D patch compressed image.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to generate 3D patch compressed images, send 3D patch compressed images, modify 3D patch compressed images and/or receive 3D patch compressed images or other types of images. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may 3D image data, and /or 3D patch compressed model data. The data may be arranged in a database and accessible through Structured Query Language (SQL) queries, or other data base query languages or operations.

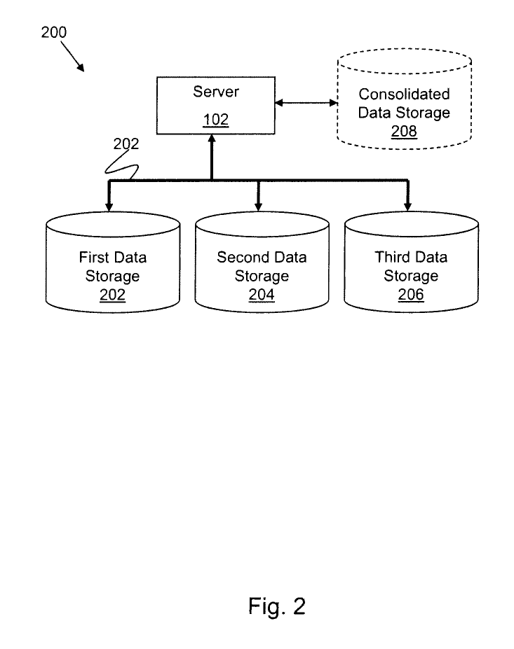

FIG. 2 illustrates one embodiment of a data management system 200 configured to store and manage data for 3D image manipulation or compression. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of 3D images, such as 3D images of clothing, 3D images of models of people, #d images from different brands, 3D images from different ecommerce businesses or the like. The information in each database may be keyed to a common field or identifier, such as brand, a type of clothing, or the like. Alternatively, the storage devices 204-208 may be arranged in a RAID configuration for storing redundant copies of the database or databases through either synchronous or asynchronous redundancy updates.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210; the server first communicating with a storage server or storage controller 106.

The server 102 may host a software application configured for 3D patch compression or 3D patch compressed model manipulation. The software application may further include modules for interfacing with the data storage devices 204-210, interfacing a network 108, interfacing with a user, and the like. In a further embodiment, the server 102 may host an engine, application plug-in, or application programming interface (API) used for 3D patch compression or file manipulation. In another embodiment, the server 102 may host a web service or web accessible software application.

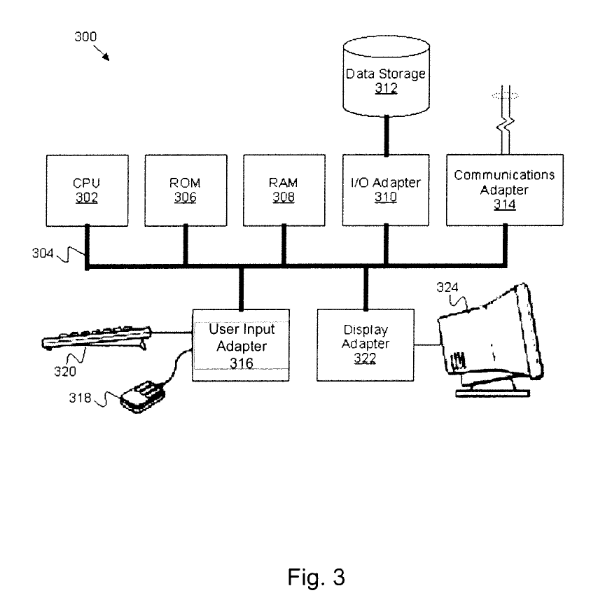

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. The computer system 300 may be adapted to run a software application configured for 3D patch compression, manipulation and/or visualization. In a further embodiment, the computer system 300 may execute an engine, application plug-in, or application programming interface (API). In another embodiment, the computer system 300 may interface with a web service or web accessible software application through the communications adapter 314.

The computer system 300 also may include Random Access Memory (RAM) 308, which may be SRAM, DRAM, SDRAM, or the like. The computer system 300 may utilize RAM 308 to store the various data structures used by a software application configured for 3D patch compression, manipulation and/or visualization. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for 3D patch compression or manipulation. In a further embodiment, the display adapter 322 may display a graphical user interface associated with a software or web-based application for 3D patch compression.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

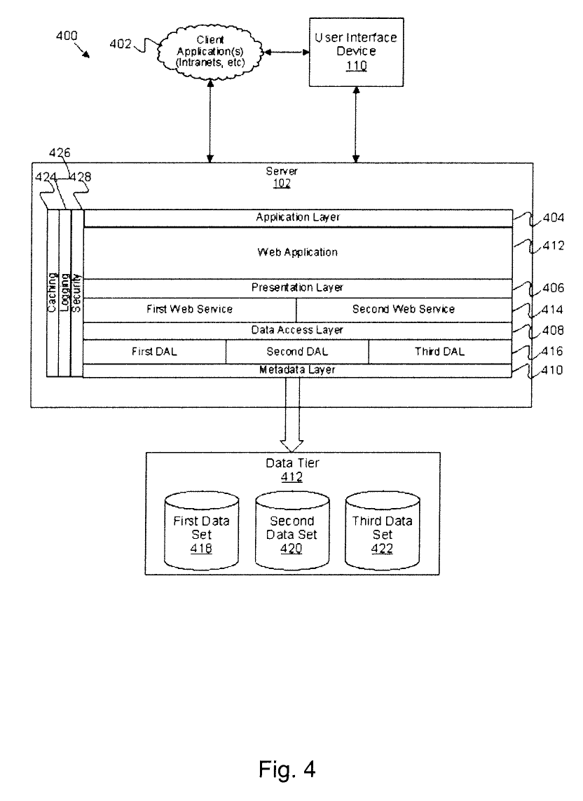

FIG. 4 illustrates one embodiment of a network-based system 400 for 3D patch compression, manipulation and/or visualization. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 422-422 that comprise a data layer or data tier 412. For example, a first data set 422, a second data set 420 and a third data set 422 may comprise a data tier 412 that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for 3D patch compression, manipulation and/or visualization that includes software modules configured to perform the steps of embodiments of the invention.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation. For example, the web application may access 3D models of clothing on one server and 3D images of models on another. The web application may also access 3D models of clothing from a certain brand on one server and 3D models of clothing from a different brand on another.

For example, a web application 412 for ecommerce, or other information may access a first web service 414 for receiving a model of an individual and a second web service 414 for receiving information related a piece of clothing. The web services 414 may receive a 3D patch compressed representation of the individual. In response, the web service 414 may return a second 3D patch compressed representation of the individual modeled with a new piece of clothing. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 412. These individual data access layers 416 may be referred to as data sockets or adapters.

The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for retrieving information or 3D patch compressed models on individual pieces of clothing, for example.

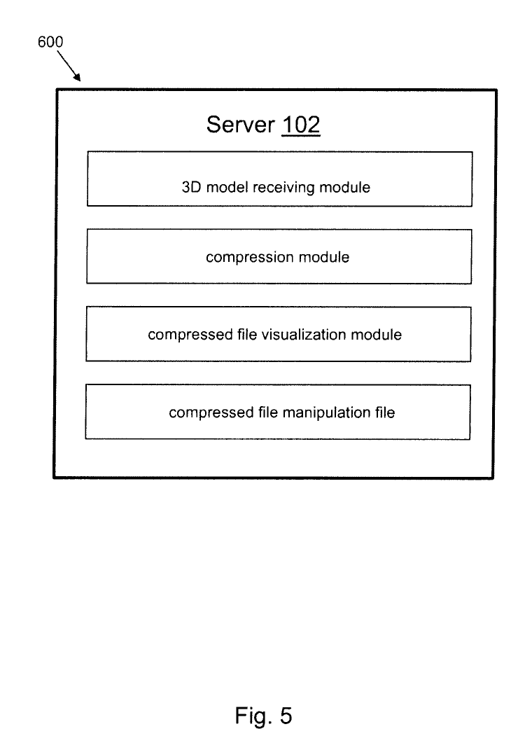

FIG. 5 illustrates one embodiment of an apparatus 600 for 3D patch compression. In one embodiment, the apparatus 600 is a server 102 configured to load and operate software modules 602-608 configured for 3D patch compression. In such embodiments, the apparatus 600 may include a 3D model receiving module, a compression module, a compressed file visualization module and a compressed file manipulation file. In a specific embodiment the system may also include a model fitting or texturizing module, as described below.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

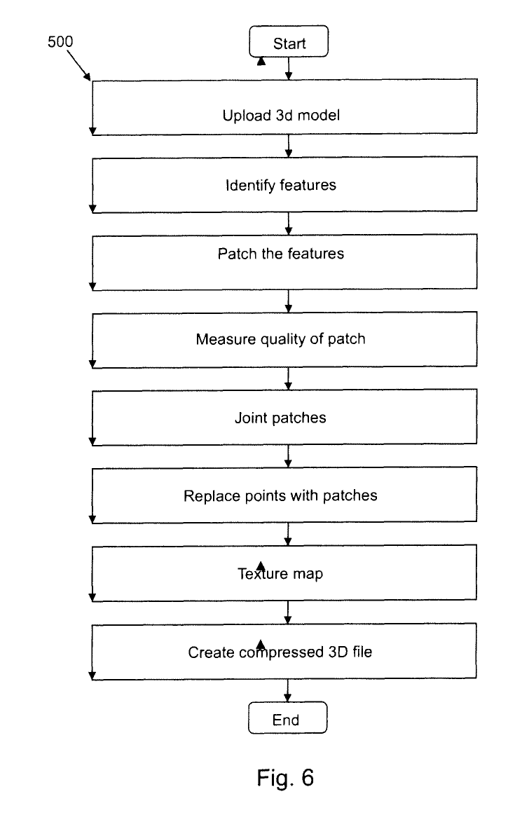

FIG. 6 illustrates an embodiment of the method of 3D patch compression. The method starts with receiving a 3D model in mesh or point form, such as a .obj, .ply or a NURBS surface model such as .3 dm. Features of the 3D model are identified by different method such as principal curvature identification, eigenvalues analysis, edge detection, and mesh segmentation and the features are fitted with patches. In embodiments of the invention, different patch identification algorithms may be used, for example, surface eigenvalues, curvature information, or orthogonal cuts. Given the 3D surface, surface eigenvalues are computed from the second and/or third eigen-mode of the Laplacian on the parametric surface, which gives an idea of where the surface will break in case of fracture, and the patches are formed at the fracture points. To calculate curvature information, places with principal curvature information are identified and are patched at the places with principal curvature information. In this case, most of the main features of the objects are captured. In the case of orthogonal cuts, a general surface is taken and is intersected with orthogonal planes, the intersections are estimated and then patched. In another case of orthogonal cuts, the intersection end patches are intersected with a grid of planes, and then patched. Patches as used herein refers to AB- Patches (N-sided Attribute based patches). To create the 3D patched model, the patches are then joined or merged together, as described below.

The quality of the patches are measured by an algorithm defined as visual closeness, via algorithms such as volume between patch and original surface, and a dimension reduction approach. In an embodiment of the invention, the quality is measured by computing the volume between the original surface and the patch surface, this gives an estimated on how good the approximation is. The result of this algorithm also has a graphical counterpart, since one can show the areas where the patch did not capture the original surface, generating a deviation map. In another embodiment of the invention, the quality is measured by building on the boundary curves with B-splines, identify interior B-splines, reducing the problem from 3D to 2D, and comparing each individual curve with its counterpart in 2D. This reduces by one dimension the problem of measuring the patch and will capture smaller details.

The individual patches are represented as a set of control points. For adjacent patches some of the control points may be merged, through the functionality of the merge patch. Merged and joined are used herein interchangeably. The patches may be merged after the mesh segmentation or patch identification step. Coming from the mesh segmentation or patch identification step, the algorithm merges adjacent patches according to the neighbor control points, this steps also adds continuity and curvature information. The continuity and curvature information is taken from the original 3D model, and is able to join two patches by sharing control points, matching the first derivatives, second derivatives and so on, for example. The points of the original file are, thus, replaced with the generated patches. The joined patches are then texture mapped and a 3D compressed file is created.

In an embodiment of the invention, the object is transformed to different shapes by using its control points and curves through patch manipulation. This produces slightly different forms of the original objects while maintaining the main features. In an embodiment of the invention, fitting another 3D patch compressed model to the original patch compressed model occurs at this point, such as cloth fitting onto an avatar based on tailor measurements. Tailoring measurements can include neck, chest, waist, hips, full shoulder, sleeves, cuff, etc. In an embodiment of the invention, in the fitting and patch merging algorithm the clothes (underlying curves) will adapt to those measurements, since all the models have already taken into account those body parts.

The 3D model may also be texturized. In the texturing algorithm, traditional texture mapping algorithms may be used, such as applying a texture map to the surface of a shape or polygon. The texture map may be a 2D image. Special consideration may be taken to patches that constitute the front, back, and sleeves, pieces of a cloth design, for example, so that the texture map looks as realistic. The source of the texture map may be a scanned version of the cloth, or may come from a database of pictures. Logos may be part of the user interface while texturing.

The initial representation is given as a 3D mesh and the output is a lossy compressed file represented with geometric patches. One embodiment of the invention is a software application that compresses 3D images with patches. In another embodiment, the degree of lossy compression can be selected according to the quality required. The paradigm is to work with stylized curves that preserve details and smoothness, so that the transformed mesh is visually equal to the original one. 3D patched compression does not have well-know issues that existing technologies have, such as ripples, and discontinuities. In one embodiment, the compression process might not be real time. Real time compression will depend on the implementation and device. In an embodiment of the invention, the decompression process and visualization is real time. Existing technology that deals with polygon reductions and mesh simplification attain up to a 98% or 40:1 rate of compression, but the quality is highly compromised. The 3D patch compression preserves high visual quality while maintaining a high rate of compression. The 3D patch compressed file may have a new digital description called “.w3d.” The w3d file may have the characteristic of being built of AB-Patches (N-sided Attribute based patches). These files have the property of being compact in storage, and flexible for further interaction for manipulation, animation and transformation. This application aims for compression, for mobile and web-browser use particularly.

An embodiment of the invention may be implemented in the following scientific areas: geometric modeling, compression algorithms, computer graphics, 3D data production and manipulation, and scientific visualization. In another embodiment of the invention, it is implemented in the following industry areas: 3D Design software for use in aeronautics, automotive, clothing, mechanics, exploration, architecture, engineering, building construction, manufacturing, media and entertainment, rich Internet application software development, web browsers, mobile devices, among others. All of these scientific fields and industry areas share in common the manipulation of 3D data, particularly the need of dealing with many different file formats and usually with huge models that require a considerable amount of storage, thus impeding collaboration and data exchange, which requires end users to buy hardware with superior capabilities constantly.

Embodiments of the invention are separated into two parts, the first being the algorithm that allows the compression from a standard 3D file (obj, .ply, or 3dm) into a new format .w3d by taking the original mesh and identifying the features, patching the main features, and merging the patches. The second is the software capable of identifying, visualizing, reading, interpreting, processing, modifying, compressing and generating the new file with the .w3d format supported by the algorithm, completing the cycle of the solution.

3D patch image conversion and viewing may be implemented in web browsers including in WEBGL, a software library that extends the capability of the JavaScript programming language to allow it to generate interactive 3D graphics within any compatible web browser and in O3D, an open source JavaScript API created by Google for creating interactive 3D graphics applications that run in a web browser window or in a XUL desktop application, for example.

In the mobile space, embodiments of the invention may be implemented in OpenGL ES, a cross-platform API for full-function 2D and 3D graphics on embedded systems—including consoles, phones, appliances and vehicles, for example. In general embodiments, the invention may be implemented in U3D, a universal compressed file format standard for 3D computer graphics data.

In embodiments of the invention, the input is a 3D mesh, vertices or connection arrays and the output is a .w3d file. The compression quality may be adjusted through a user input. In embodiments of the invention, the processing time is in kb/s. Embodiments of the invention may be implemented to be multi-platform able, or platform specific. Embodiments of the invention may be supported on a variety of browsers, such as WegGL: Mozilla, Safari, Chrome, and Firefox, for example. The invention may be implemented in a variety of programming languages, such as C++, java, C, javascript, WebGLor others. The software development language may depend on the type of device used, such as Objective C or OpenGL ES on the iPhone, iPad, or iTouch.

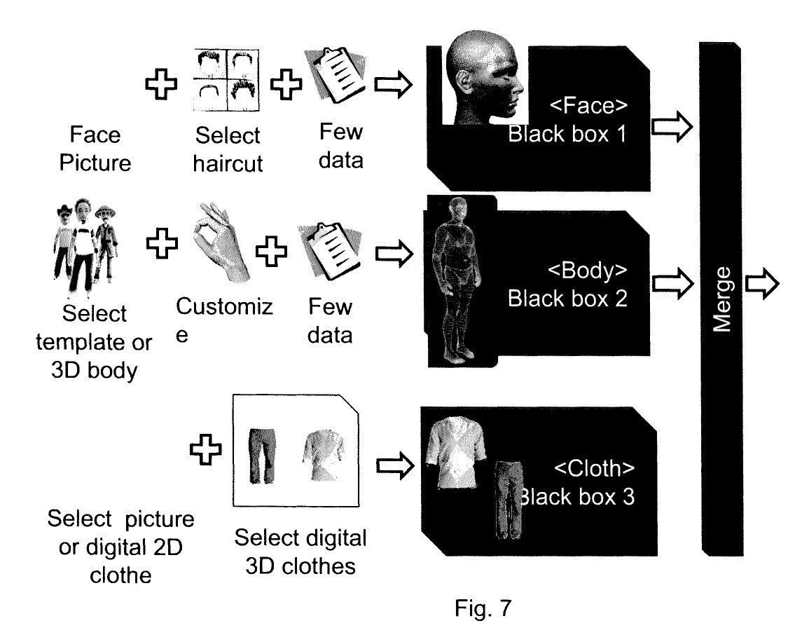

The 3D patch compression may be used in multiple different applications, such as in ecommerce, CAD software and gaming. In the example of ecommerce, a user may submit a picture of their face and select facial features such as a haircut, beard, mustache, and/or other facial accessories, as shown in FIG. 7. The user may also input data such as nationality, distance between the eyes, nose to eyes, and so forth. The 3D patch compression will then deform a template face to match the picture by texturing mapping the input facial picture onto a constructed face 3D patch compressed model. Some face points are characterized by the user, and an algorithm transform the template face according to those points, such as by 3D compression manipulation that fits control points and curves from the base 3D model to the 3D model to be fitted. The output is a 3D facial model, texture mapped with the picture, with the additional previously selected facial features such as hair style.

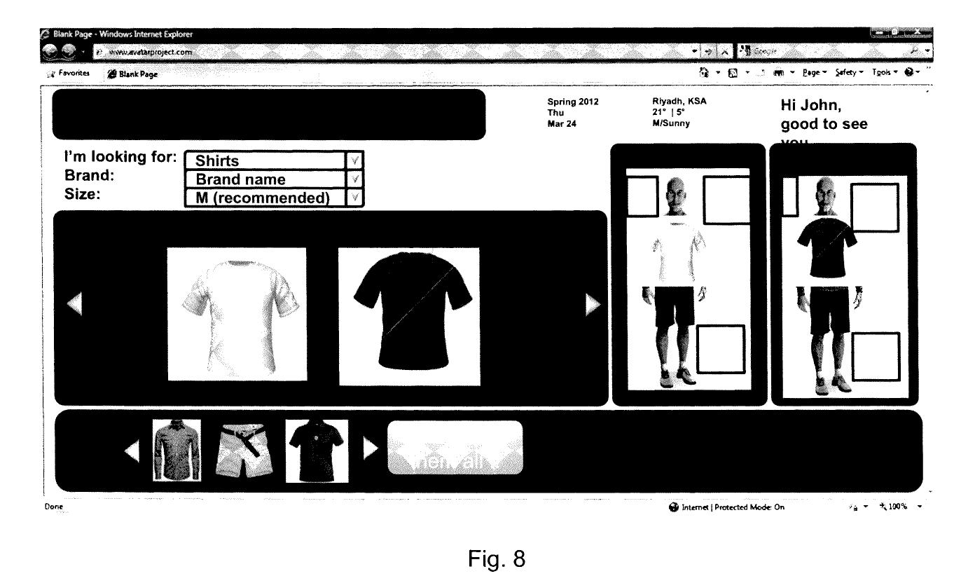

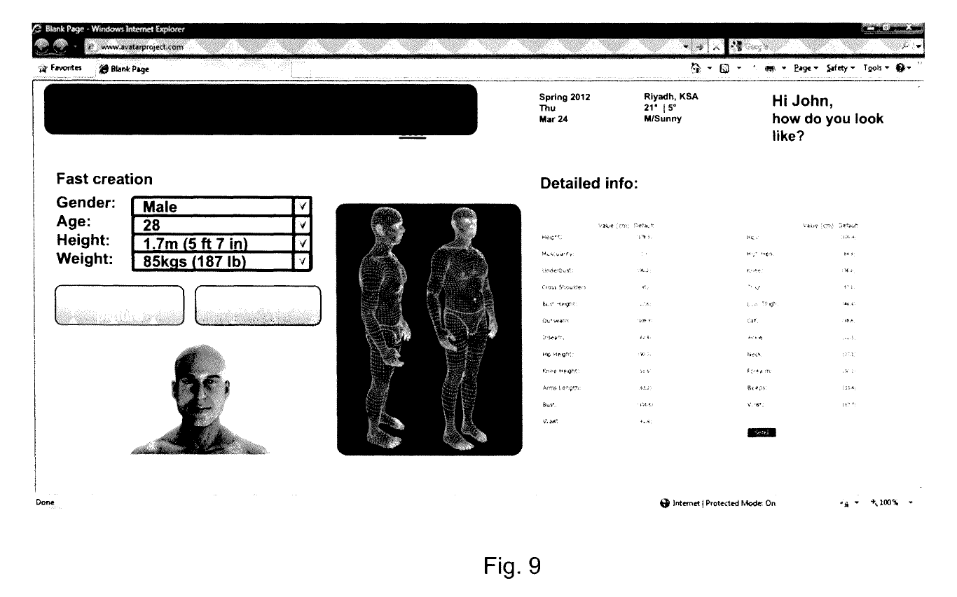

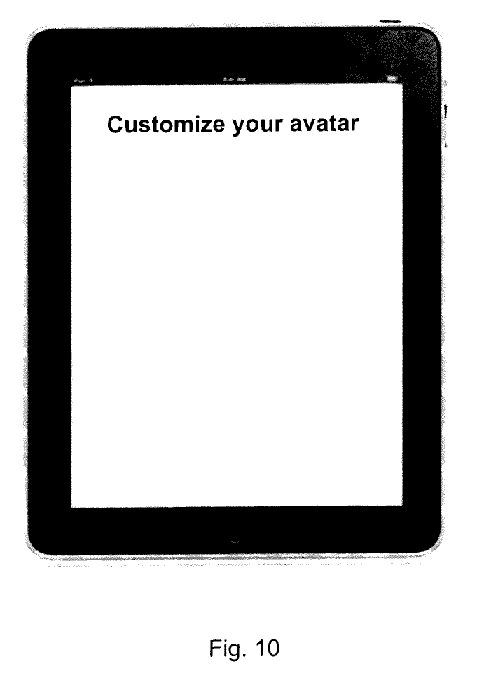

In another example of an application for the 3D patch compression, a user will select a body template, customize the features, and input additional measurements such as height and weight, as shown in FIGS. 9 and 10. The 3D patch compression software will then deform then output a 3D body representation, which may also be called a virtual avatar, texture mapped with a selected skin color. The user may then browse a selection of clothing and try the clothing on the avatar, as shown in FIG. 8. When trying the clothing on the 3D patch compression software takes the measurements previously input by the user and adjusts to it. This naturally depends on the size of the clothing and the size of the body. Previously identified features are used to fit the 3D clothing model with the 3D avatar model, such as by 3D compression manipulation that fits control points and curves from the base 3D model to the 3D model to be fitted. In one embodiment, if the clothing size and the body do not match, a red stop light will appear, for example. If the clothes do fit, a green light may appear, and if there is a question of fit, a yellow light may appear, for example. The output of this is a 3D representation of the avatar fitted with the selected pieces of clothing.

Another embodiment of the invention is a software program that is used to visualize the compressed 3D patch file. This software is also able to modify the compressed representation, allowing real time modification, adjustments, animation and transformation. In the case of animation, the 3D patch compressed model may have predetermined poses, such as by a 3D patch compressed avatar. The software may run on mobile devices such as the iPad, iPhone, Blackberry, tablet computers, mobile phones, and so forth. The software may also run in a web browser, or as an additional plug in for text type document such as word and PDF. The 3D patch compression visualization software may also be called an embedded 3D canvas. The software may also be able to modify 3D patch compressed files such as by texture mapping or the like.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. An apparatus for 3D patch compression of digital objects, the apparatus comprising:
a 3D model receiving module configured to receive a 3D model;
a compression module configured to compress the 3D file by transforming the 3D model into a 3D patch compressed model;
a 3D patch compressed visualization module configured to view the 3D patch compressed model; and
a 3D patch compressed manipulation module configured to manipulate the 3D patch compressed model.

2. The apparatus of claim 1, wherein the received 3D models are in a 3D mesh, vertices or connection arrays, or NURBS representation.

3. The apparatus of claim 1, wherein the compression module further comprises:
a feature identification module configured to identify main features of the 3D model;
a patch module configured to patch the main features of the 3D model; and
a patch joining module configured to join the main feature patches.

4. The apparatus of claim 3, wherein the feature identification module is configured to use surface eigenvalues, curvature information, or orthogonal cuts to identify the main features.

5. The apparatus of claim 3, further comprising a quality measure module configured to measure the quality of the main feature patches.

6. The apparatus of claim 5, wherein the quality measure module is configured to use volume between patch and original surface, or curves identification to measure the quality of the main feature patches.

7. The apparatus of claim 3, wherein the patch joining module is configured to merge adjacent patches according to neighbor control points taken from the received 3D model by matching the first derivatives and/or second derivatives.

8. The apparatus of claim 3, further comprising:
a texture map receiving module configured to receive a texture map; and
a texture mapping module configured to texture map the joined patches with the texture map.

9. The apparatus of claim 1, wherein the 3D model receiving module is configured to receive a 3D model of a human body.

10. The apparatus of claim 9, wherein the 3D patch compressed manipulation model is further configured to manipulate measurements of the 3D model of a human body.

11. The apparatus of claim 8, wherein the texture mapping module is configured to texture map a representation of clothing onto a 3D model of a human body.

12. The apparatus of claim 8, wherein the texture mapping module is configured to texture map a representation of a human face onto a 3D model of a human body.

13. The apparatus of claim 3, wherein the 3D patch compressed manipulation module is further configured to modify the texture mapping of the 3D model.

14. The apparatus of claim 1, wherein the 3D patch compressed manipulation module is further configured to change the quality of the 3D patch compressed model.

15. The apparatus of claim 1, wherein the 3D patch compressed manipulation module is further configured to change measurements of the 3D patch compressed model.

16. The apparatus of claim 1, wherein the 3D patch compressed visualization module is configured to give a 360 degree view of the 3D patch compressed model.

17. A computer program product comprising a computer readable medium having computer usable program code executable to perform operations for 3D patch compression of digital objects, the operations of the computer program product comprising:
receiving a 3D model;
compressing the 3D model by transforming the 3D model into a 3D patch compressed model;
viewing the 3D patch compressed model;
manipulating the 3D patch compressed model; and
outputting the 3D patch compressed model.

18. The computer program product of claim 17, wherein the received 3D models are in a 3D mesh, vertices or connection arrays representation.

19. The computer program product of claim 17, wherein compressing the 3D model further comprises:
identifying main features of the 3D model;
patching the main features of the 3D model; and
joining the main feature patches.

20. The computer program product of claim 19, wherein identifying the main features of the 3D model comprises calculating the second and/or third eigen mode of the laplacian on the parametric surface of the model.

21. The computer program product of claim 19, wherein identifying the main features of the 3D model comprises identifying places with principal-curvature information and patching along the identified places.

22. The computer program product of claim 19, wherein identifying the main features of the 3D model comprises taking 3D model surface and intersecting it with orthogonal places and estimating the intersection.

23. The computer program product of claim 19, wherein joining the main feature patches comprises merging adjacent patches according to neighbor control points taken from the received 3D model by matching the first derivatives and/or second derivatives.

24. The computer program product of claim 17, further comprising measuring the quality of the main feature patches.

25. The computer program product of claim 24, wherein measuring the quality of the main feature patches comprises calculating the volume between the received 3D model and the 3D patch compressed model.

26. The computer program product of claim 24, wherein measuring the quality of the main feature patches comprises b-spline curves identification.

27. The computer program product of claim 17, further comprising:
receiving a texture map; and
texture mapping the joined patches with the texture map.

28. The computer program product of claim 27, wherein the texture map is a representation of clothing.

29. The computer program product of claim 27, wherein the texture map is a representation of a human face.

30. The computer program product of claim 17, wherein the 3D model is a model of a human body.

31. The computer program product of claim 17, wherein manipulating the 3D patch compressed model comprises manipulating measurements of the 3D model of a human body.

32. The computer program product of claim 17, wherein manipulating the 3D patch compression model comprises fitting a second 3D patch compressed model to the 3D patch compressed model.

33. The computer program product of claim 17, wherein manipulating the 3D patch compressed model comprises modifying the texture mapping of the 3D model.

34. The computer program product of claim 17, wherein manipulating the 3D patch compressed model comprises changing the quality of the 3D patch compressed model.

35. The computer program product of claim 17, wherein manipulating the 3D patch compressed model comprises changing measurements of the 3D patch compressed model.

36. An apparatus to view and manipulate a 3D patch compressed model, the apparatus comprising:
a 3D model receiving module configured to receive a 3D patch compressed model;
a 3D patch compressed visualization module configured to view the 3D patch compressed model; and
a 3D patch compressed manipulation module configured to manipulate the 3D patch compressed model.

37. The apparatus of claim 36, further comprising:
a texture map receiving module configured to receive a texture map; and
a texture mapping module configured to texture map the joined patches with the texture map.

38. The apparatus of claim 36, wherein the 3D model receiving module is configured to receive a 3D model of a human body.

39. The apparatus of claim 38, wherein the 3D patch compressed manipulation model is further configured to manipulate measurements of the 3D model of a human body.

40. The apparatus of claim 37, wherein the texture mapping module is configured to texture map a representation of clothing onto a 3D model of a human body.

41. The apparatus of claim 37, wherein the texture mapping module is configured to texture map a representation of a human face onto a 3D model of a human body.

42. The apparatus of claim 37, wherein the 3D patch compressed manipulation module is further configured to modify the texture mapping of the 3D model.

43. The apparatus of claim 36, wherein the 3D patch compressed manipulation module is further configured to change the quality of the 3D patch compressed model.

44. The apparatus of claim 36, wherein the 3D patch compressed manipulation module is further configured to change measurements of the 3D patch compressed model.

45. The apparatus of claim 36, wherein the 3D patch compressed visualization module is configured to give a 360 degree view of the 3D patch compressed model.

46. A system for 3D patch compression of digital objects, the system comprising:
a data storage device configured to store a database comprising one or more 3D patch compressed base models;
a data storage device configured to store a database comprising one or more 3D patch compressed texture models;
a server in data communication with the data storage device, suitably programmed to:
fit one or more 3D patch compressed texture models to a compressed base model; and
send the fit 3D patch compressed texture model.

47. A method for 3D patch compressing a model, the method comprising:
receiving a 3D representation of a first model;
receiving a texture map or a second 3D patch compressed model;
identifying the main features of the model;
patching the identified main features of the first model;
joining the patches;
texture mapping the joined patches with the texture map or fitting the second 3D patch compressed model to the joined patched model; and
sending a compressed texture mapped model to a visualization device.

48. The method of claim 47, wherein the received 3D representation of a model is a 3D mesh, vertices or connection arrays representation.

49. The method of claim 47, further comprising measuring the quality of the main feature patches.

50. The method of claim 49, wherein measuring the quality of the main feature patches comprises calculating the volume between the patched model and the original model.

51. The method of claim 49, wherein measuring the quality of the main feature patches comprises identifying the curves as b-splines.

52. The method of claim 47, wherein the received 3D model is a model of the human body.

53. The method of claim 52, further comprising manipulating measurements of the 3D model of a human body.

54. The method of claim 47, wherein the texture map is a picture of a human face.

55. The method of claim 47, wherein the texture map is a picture or 3D patch compressed image of clothing.

56. The method of claim 47, wherein patching comprises using a surface-eigen value algorithm, a curvature information algorithm, or an orthogonal cut algorithm.

57. The method of claim 47, wherein joining the patches comprises merging adjacent patches according to neighbor control points and matching the one or more derivative.

58. The method of claim 47, further comprising changing the quality of the 3D patch compressed model.

59. The method of claim 47, further comprising changing measurements of the 3D patch compressed model.

60. The method of claim 47, wherein the 3D patch compressed manipulation module is configured to fit a second 3D patch compressed model onto the 3D patch compressed model.

61. The method of claim 60, wherein the 3D patch compressed model is a model of a human body, and the second 3D patch compressed model is a model of a piece of clothing.
